(19) United States
(12) Patent Application Publication
(10) Pub. No.: US 2025/0362838 A1
(43) Pub. Date: Nov. 27, 2025

(54) IMAGE FORMING SYSTEM THAT GENERATES JOB TICKET INDICATING SETTING DETAIL OF GENERAL SETTING FILE OR EXCEPTIONAL SETTING FILE, DESIGNATED BY INPUTTED INSTRUCTION, ELECTRONIC TERMINAL, AND PRINT CONTROL METHOD

(71) Applicant: KYOCERA Document Solutions Inc., Osaka (JP)

(72) Inventors: Shunsuke SASAKI, Osaka (JP); Takanori MIYAMOTO, Osaka (JP)

(73) Assignee: KYOCERA Document Solutions Inc., Osaka (JP)

(21) Appl. No.: 19/215,390

(22) Filed: May 22, 2025

(30) Foreign Application Priority Data
May 23, 2024 (JP) 2024-084412

(51) Int. Cl. G06F 3/12

(52) U.S. Cl. CPC G06F 3/1205; G06F 3/1206; G06F 3/1257; G06F 3/1275

(57) ABSTRACT

An image forming system includes an image forming device, a controller, a storage device, and an input device. The image forming device forms an image on a recording sheet. The controller causes the image forming device to form the image according to a job ticket. The storage device contains a general setting file specifying print setting for all pages, and an exceptional setting file specifying print setting for a predetermined page range, separately from each other. The controller retrieves the general setting file or exceptional setting file designated by the instruction inputted to the input device, from the storage device, and generates the job ticket indicating a setting detail specified by the general setting file or exceptional setting file retrieved.

### INCORPORATION BY REFERENCE

This application claims priority to Japanese Patent Application No. 2024-084412 filed on May 23, 2024, the entire contents of which are incorporated by reference herein.

### BACKGROUND

The present disclosure relates to an image forming system, an electronic terminal, and a print control method.

In the field of commercial printing, where suppliers receive orders for creating printed materials from customers, and supply the printed materials according to the needs of the customers, a print management method has been developed, driven by the spread of digital printing techniques. The method includes creating and managing a job ticket on the basis of print settings specified in a print job, to facilitate the print setting by utilizing such job ticket, when performing the print job as a reprinting operation, or as a routinized work.

A first technique currently known enables print settings of a print job, including image data representing a plurality of pages, to be partially modified. A second known technique prevents, with respect to a saved print job, disagreement between the setting desired by the user and the setting recognized by the image forming system.

In addition, a third known technique includes notifying to the user, at the time of changing the print setting of the print data, the items in the print setting that remain valid or become invalid. Further, a fourth technique is known that facilitates the user to compare between images to be printed under different print settings.

### SUMMARY

The disclosure proposes further improvement of the foregoing technique.

In an aspect, the disclosure provides an image forming system including an image forming device, a controller, a storage device, and an input device. The image forming device forms an image on a recording sheet. The controller includes a processor, and causes the image forming device to form the image according to a job ticket, when the processor executes a control program. The storage device contains a general setting file specifying print setting for all pages, and an exceptional setting file specifying print setting for a predetermined page range, separately from each other. To the input device, an instruction of a user is inputted. The controller retrieves the general setting file or exceptional setting file designated by the instruction inputted to the input device, from the storage device, and generates the job ticket indicating a setting detail specified by the general setting file or exceptional setting file retrieved.

In another aspect, the disclosure provides an electronic terminal including a controller, a storage device, and an input device. The controller includes a processor, and causes an image forming apparatus to form an image according to a job ticket, when the processor executes a control program. The storage device contains a general setting file specifying print setting for all pages, and an exceptional setting file specifying print setting for a predetermined page range, separately from each other. To the input device, an instruction of a user is inputted. The controller retrieves the general setting file or exceptional setting file designated by the instruction inputted to the input device, from the storage device, and generates the job ticket indicating a setting detail specified by the general setting file or exceptional setting file retrieved.

In still another aspect, the disclosure provides a print control method including a storage process including separately creating a general setting file specifying print setting for all pages, and an exceptional setting file specifying print setting for a predetermined page range, and storing the general setting file and the exceptional setting file in a storage device, a job ticket generation process including retrieving the general setting file or exceptional setting file from the storage device, according to an instruction of a user, and generating a job ticket indicating a setting detail specified by the general setting file or exceptional setting file retrieved, and an image forming process including causing an image forming device to form an image according to the job ticket.

### BRIEF DESCRIPTION OF THE DRAWINGS

FIG. 1 is a schematic diagram showing an image forming system;

FIG. 2 is a block diagram showing an electrical configuration of the image forming system; and

FIG. 3 to FIG. 8 are schematic drawings, each showing a display example of a display device of an electronic terminal.

### DETAILED DESCRIPTION

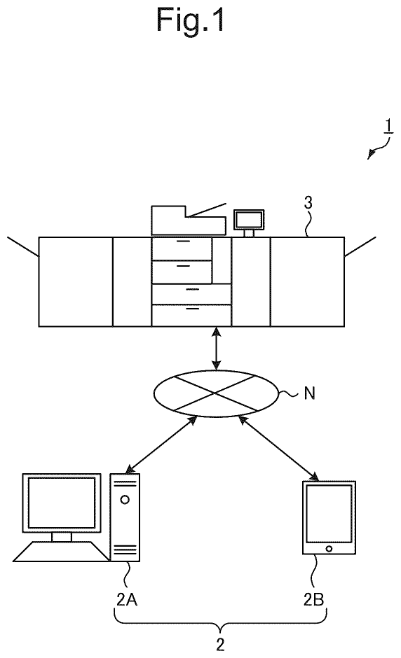

Hereafter, an image forming system, an electronic terminal, and a print control method according to an embodiment of the disclosure will be described, with reference to the drawings. FIG. 1 is a schematic diagram showing the image forming system 1 according to the embodiment of the disclosure. The image forming system 1 includes the electronic terminal 2 and an image forming apparatus 3. The electronic terminal 2 may include a personal computer (PC) 2A, and a mobile terminal 2B such as a smartphone or a tablet terminal. The image forming apparatus 3 is, for example, a multifunction peripheral that prints printed materials (pamphlets, fliers, posters, and so forth) for the activities of enterprises or organizations. A network N is for transmission and reception of data, such as a local area network (LAN) or the internet.

The electronic terminal 2 transmits a print job to the image forming apparatus 3, according to an instruction of a user. The image forming apparatus 3 executes the printing operation, according to the print job received.

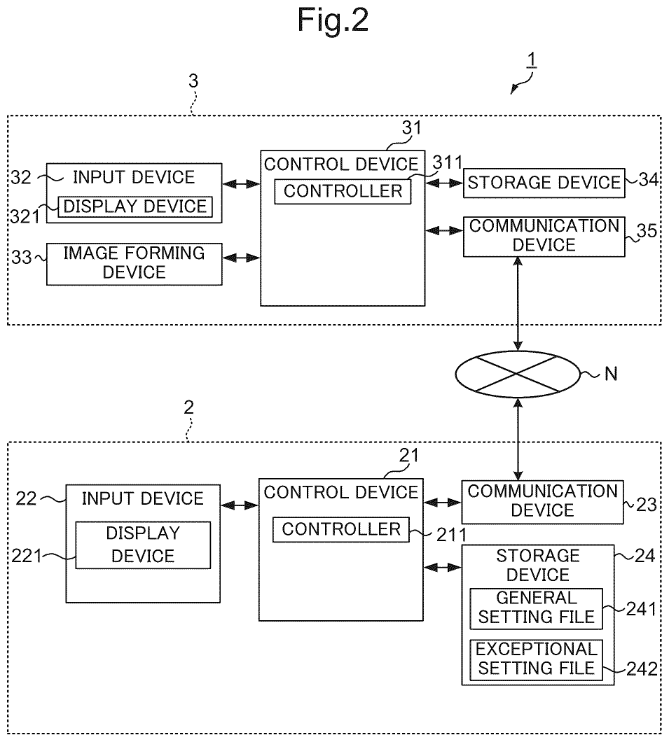

FIG. 2 is a block diagram showing an electrical configuration of the image forming system 1 according to the embodiment of the disclosure. The electronic terminal 2 includes a control device 21, an input device 22, a communication device 23, and a storage device 24.

The input device 22 includes pointing devices such as a keyboard and a mouse. To the input device 22, various instructions of the user are inputted. The display device 221 includes a liquid crystal display (LCD), or the like. When the electronic terminal 2 is configured as a mobile terminal, the display device 221 may be integrally formed with a touch panel (input device 22).

The communication device 23 is a communication module for transmitting and receiving various types of data, to and from an external device such as the image forming apparatus 3, via a network N such as the internet. The storage device 24 is a large-capacity memory unit such as a solid state drive (SSD) of a hard disk drive (HDD), storing therein various programs and data tables. The storage device 24 contains a general setting file 241 and an exceptional setting file 242.

The storage device 24 contains a control program for executing the print control method according to the embodiment of the disclosure. However, the control program may be a web application stored in a storage on the web, instead of being stored in the storage device 24.

The control device 21 includes a processor, a random-access memory (RAM), a read-only memory (ROM), and so forth. The processor is, for example, a central processing unit (CPU), a micro processing unit (MPU), or an application specific integrated circuit (ASIC). The control device 21 acts as a controller 211, when the processor executes a control program stored in the ROM. The controller 211 serves to control the overall operation of the electronic terminal 2.

Now, the type of the print setting includes a general setting specifying the print setting for all pages, and exceptional setting specifying the print setting for a partial page range. In other words, the general setting specifies the items of the print setting and set values for each of the items, applicable to all the pages. The exceptional setting specifies the items of the print setting and set values for each of the items, applicable only to a predetermined partial page range.

The controller 211 generates a job ticket indicating a setting detail according to each of the general setting and the exceptional setting. The job ticket refers to a file including the settings necessary for executing the print jog, in the field of industrial printing. The controller 211 generates the job ticket, for example, in the JDF or XJDF data format.

The controller 211 separately creates the file of the general setting and the exceptional setting, according to the instruction of the user inputted to the input device 22, and stores these files in the storage device 24.

In this embodiment, in particular, the controller 211 generates the job ticket indicating the setting detail, according to a general setting file 241 specifying the general setting in the form of a file, and an exceptional setting file 242 specifying the exceptional setting in the form of a file.

The image forming apparatus 3 receives the job ticket from the electronic terminal 2, and executes the printing operation under the print setting according to the job ticket. When the image forming apparatus 3 is scheduled to periodically execute the printing operation, for example every month or every week, it is troublesome for the electronic terminal 2 to generate the job ticket with a part of the print detail changed, for each of the print jobs. In addition, with the existing technique, the job ticket is generated from a single file collectively containing the general setting and the exceptional setting.

There are cases where a part of only either of the general setting and the exceptional setting needs to be changed, with respect to the print setting indicated by the job ticket. Here, it will be assumed that, for example, a job ticket A has been generated on the basis of a general setting A1 and an exceptional setting A2, and the image forming apparatus 3 has performed the printing operation according to the job ticket A. Then, in the case where, the next month, the printing operation has to be performed on the basis of the general setting A1, and an exceptional setting B2 in which a shade has been changed in some pages (different from the exceptional setting A2), the job ticket A is no longer usable, and a new job ticket B has to be generated on the basis of the general setting A1 and the exceptional setting B2.

As another example, when the printing operation has to be performed on the basis of the general setting B1 in which the sheet type has been changed for all the pages, and the exceptional setting A2, the job ticket A is no longer usable, and a new job ticket C has to be generated on the basis of the general setting B1 and the exceptional setting A2.

According to this embodiment, in contrast, the controller 211 separately creates the files of the general setting and the exceptional setting, used for generating the job ticket, thus creating the general setting file 241 and the exceptional setting file 242, and stores these files in the storage device 24. The controller 211 combines the general setting file and the exceptional setting file designated by the user, among the general setting files 241 and the exceptional setting files 242 stored in the storage device 24, thereby generating the job ticket indicating the setting detail specified by the general setting file and the exceptional setting file.

Accordingly, in the case of generating a new job ticket, by utilizing one of the general setting file and the exceptional setting file constituting the job ticket as it is, and changing the setting detail specified by the other file, the new job ticket can be generated by substituting the other file with another one. Therefore, the trouble and the time required for generating a new job ticket can be reduced.

According to this embodiment, the general setting file 241 and the exceptional setting file 242, created in the form of files, are stored in the storage device 24 of the electronic terminal 2. Instead, the general setting file 241 and the exceptional setting file 242 may be stored in a network storage connected to the network N. Storing these files in the network storage enables other electronic terminals 2 connected to the network N to retrieve the general setting file and the exceptional setting file from the network storage, thereby generating the job ticket.

Alternatively, the general setting file and the exceptional setting file may be stored in the storage device 34 of the image forming apparatus 3. In this case, the controller 211 of the electronic terminal 2 transmits the general setting file and the exceptional setting file to the image forming apparatus 3 via the communication device 23, so that the controller 311 of the image forming apparatus 3 stores the general setting file and the exceptional setting file received via the communication device 35, in the storage device 34.

To generate the job ticket, the electronic terminal 2 transmits a request to provide the general setting file and the exceptional setting file, designated by the instruction inputted by the user to the input device 22 of the electronic terminal 2, to the image forming apparatus 3 via the communication device 23. The controller 311 of the image forming apparatus 3 retrieves the general setting file and the exceptional setting file designated by the request, from the storage device 34, and transmits the files to the electronic terminal 2, via the communication device 35.

Hereunder, an electrical configuration of the image forming apparatus 3 will be described. The image forming apparatus 3 includes a control device 31, an input device 32, an image forming device 33, a storage device 34, and a communication device 35.

The input device 32 includes hard keys such as an enter key and a start key, for inputting various actions or confirming settings, and a display device 321. To the input device 32, various instructions of the user are inputted. The display device 321 includes a liquid crystal display (LCD), or the like. The display device 321 displays an operation screen, or messages. The display device 321 may be integrally constituted with a touch panel.

The image forming device 33 prints an image on a sheet, according to the job ticket received from the electronic terminal 2. The storage device 34 is a large-capacity memory unit storing therein image data, various programs, and data tables. The communication device 35 is a communication module for transmitting and receiving various types of data, for example print data, to and from an external device such as the electronic terminal 2, via a network N such as the internet.

The control device 31 includes a processor, a RAM, a ROM, and so forth. The processor is, for example, a CPU, an MPU, or an ASIC. The control device 31 acts as a controller 311, when the processor executes a control program stored in the ROM. The controller 311 serves to control the overall operation of the image forming apparatus 3.

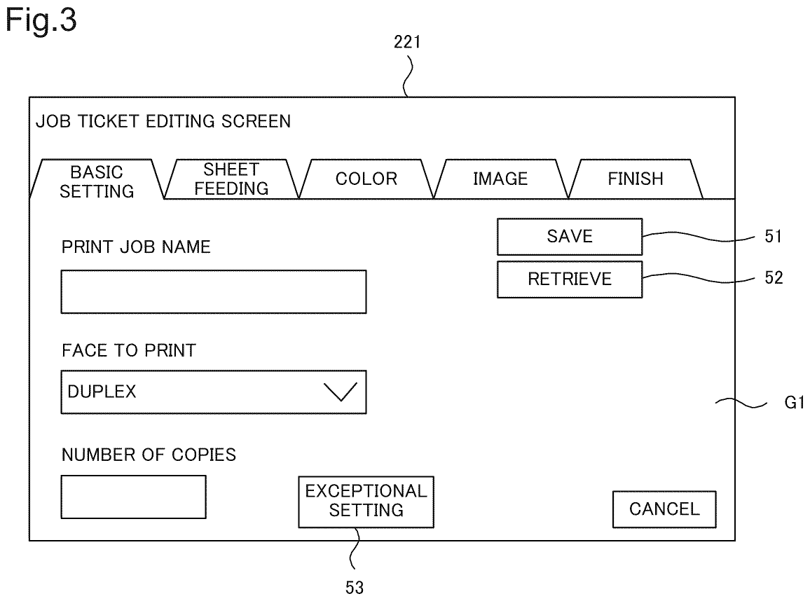

Hereunder, an editing process of the job ticket will be described. FIG. 3 to FIG. 8 are schematic drawings each showing a display example of the display device 221 of the electronic terminal 2. FIG. 3 illustrates an example of a job ticket editing screen G1.

The controller 211 of the electronic terminal 2 causes the display device 221 to display the job ticket editing screen G1. The instruction to specify the detail of the job ticket is inputted to the input device 22, according to the operation performed by the user, when the job ticket editing screen G1 is displayed, on the key of the input device 22, or on the touch panel provided on the display device 221.

The setting detail indicated by the instruction, inputted when the job ticket editing screen G1 is displayed, corresponds to the setting detail specified by the general setting file, created for all the pages to be printed. The instruction indicating the setting detail specified by the exceptional setting file is to be inputted when another screen, different from the job ticket editing screen G1, is displayed.

The controller 211 creates the general setting file, for example, in the XJDF data format, on the basis of the setting detail indicated by the instruction, inputted by the user via the input device 22 or touch panel, when the job ticket editing screen G1 is displayed.

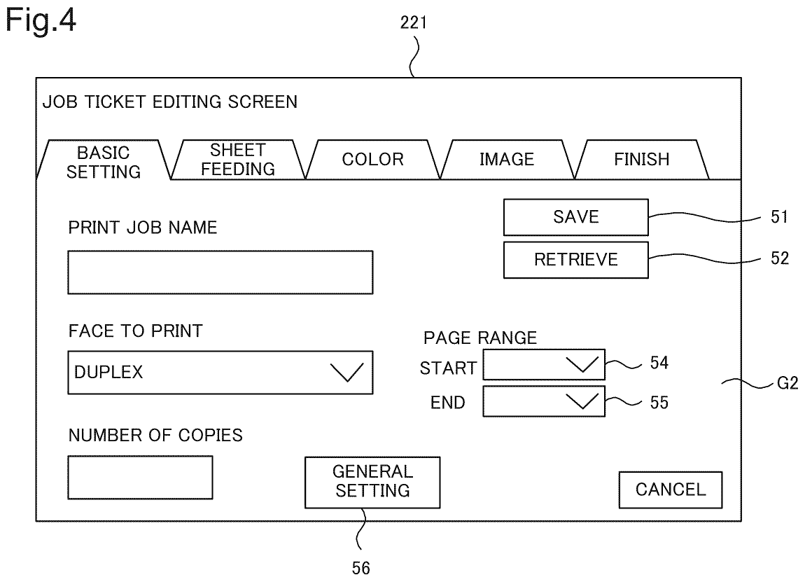

When the user presses a button 53 displayed in the job ticket editing screen G1, the controller 211 receives the instruction to display an editing screen G2 for the exceptional setting file associated with the button 53, via the input device 22. The controller 211 causes the display device 221 to display the editing screen G2 for the exceptional setting file shown in FIG. 4, according to the instruction.

The editing screen G2 for the exceptional setting file includes, for the purpose of designating a page range to which the print setting of the exceptional setting file is to be applied, a pull-down button 54 for designating the start page number, and a pull-down button 55 for designating the end page number. The setting detail indicated by the instruction, inputted when the editing screen G2 for the exceptional setting file is displayed, corresponds to the setting detail specified by the exceptional setting file, created for a part of all the pages to be printed.

The controller 211 creates the exceptional setting file, for example, in the XJDF data format, on the basis of the setting detail indicated by the instruction, inputted by the user via the input device 22 or touch panel, when the editing screen G2 for the exceptional setting file is displayed.

The editing screen G2 for the exceptional setting file also includes a button 56, for receiving the instruction to shift the screen to the editing screen for the general setting file. When the button 56 is pressed by the user, the controller 211 receives the instruction to display the job ticket editing screen G1 associated with the button 56, via the input device 22, and causes the display device 221 to display the job ticket editing screen G1.

When the user inputs the instruction to generate the job ticket to the input device 22, after the general setting file and the exceptional setting file are created as above, the controller 211 generates the job ticket indicating the setting detail specified by the general setting file and the exceptional setting file, in a predetermined data format (in this case, XJDF data format), according to the instruction.

The controller 211 transmits the job ticket generated as above, to the image forming apparatus 3 via the communication device 23, according to a print execution instruction (identification of data to be printed inclusive), inputted by the user to the input device 22 after the job ticket is generated. Upon receipt of the job ticket via the communication device 35, the controller 311 of the image forming apparatus 3 causes the image forming device 33 to form the image according to the job ticket.

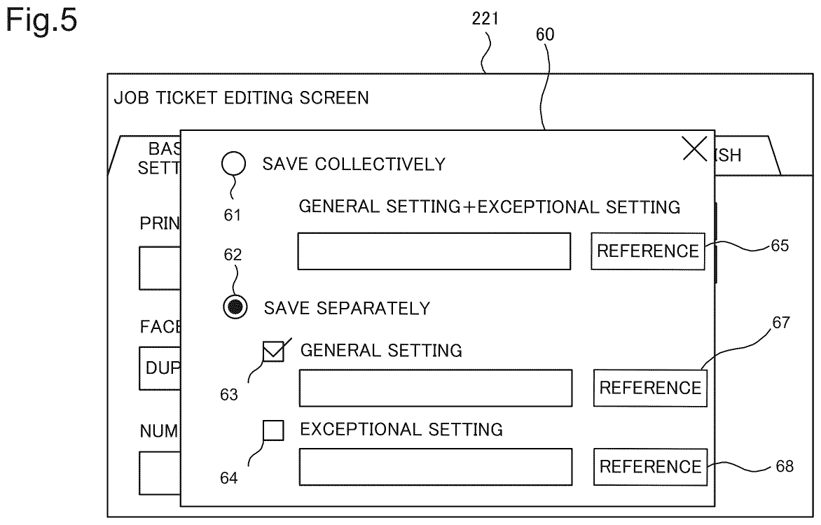

To save the general setting file or exceptional setting file created as above, the user inputs the instruction to display the job ticket editing screen G1 or editing screen G2 for the exceptional setting file, to the input device 22. The controller 211 causes the display device 221 to display the job ticket editing screen G1 or editing screen G2 for the exceptional setting file, according to the instruction. When the user presses a button 51, on the job ticket editing screen G1 or editing screen G2 for the exceptional setting file, the controller 211 receives the instruction to display a window 60 via the input device 22, and causes the display device 221 to display the window 60 as shown in FIG. 5, according to the instruction.

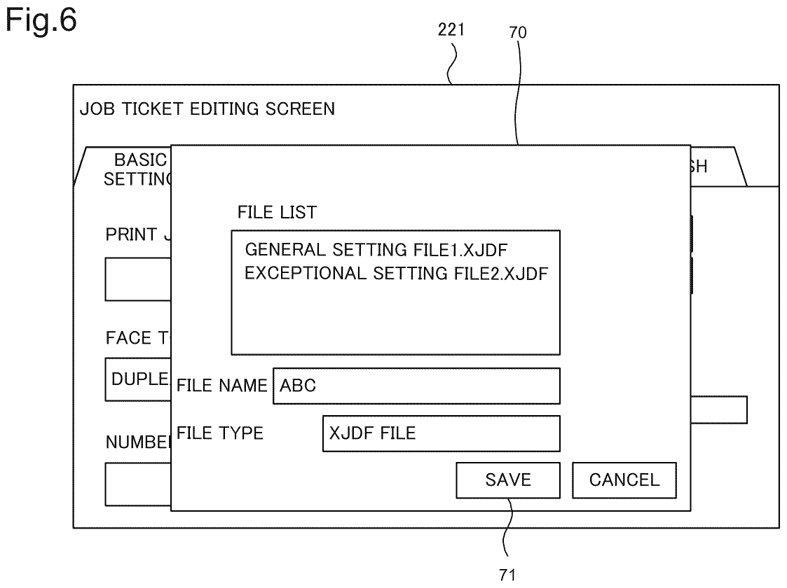

When the user presses a radio button 61 while the window 60 is displayed, the controller 211 receives the instruction to collectively save the general setting file and the exceptional setting file, via the input device 22. When the user presses a reference button 65 at this point, the controller 211 receives the instruction to display a window 70 via the input device 22, and causes the display device 221 to display the window 70 as shown in FIG. 6, according to the instruction.

The window 70 includes a list of files, including the general setting files and the exceptional setting files already stored in the storage device 24 at the time that the window 70 has been displayed. When the user inputs the instruction designating the file names of the general setting file and the exceptional setting file to the input device 22, and then presses a save button 71 thereby inputting the instruction to save the general setting file and the exceptional setting file to the input device 22, while the window 70 is displayed, the controller 211 separately recognizes the general setting file and the exceptional setting file, created at the time that the instruction has been inputted, and stores the combination of the general setting file and the exceptional setting file in the storage device 24, with the designated file name assigned.

As another example, when the user presses a radio button 62 and a checkbox 63 while the window 60 is displayed, the controller 211 receives the instruction to save only the general setting file, via the input device 22. At this point, the user may press a reference button 67, when the file name is to be inputted. When the reference button 67 is pressed, the controller 211 receives the instruction to display the window 70 via the input device 22, and causes the display device 221 to display the window 70 as shown in FIG. 6, according to the instruction.

When the user inputs the instruction designating the file name of the general setting file to the input device 22, and then presses the save button 71 thereby inputting the instruction to save the general setting file to the input device 22, while the window 70 is displayed, the controller 211 stores the general setting file, created at the time that the instruction has been inputted, in the storage device 24, with the designated file name assigned.

When the user presses the radio button 62 and a checkbox 64 while the window 60 is displayed, the controller 211 receives the instruction to save only the exceptional setting file, via the input device 22. At this point, the user may press a reference button 68, when the file name is to be inputted. When the reference button 68 is pressed, the controller 211 receives the instruction to display a window for assigning a name to the exceptional setting file, via the input device 22, and causes the display device 221 to display the window 70, according to the instruction.

When the user inputs the instruction designating the file name of the exceptional setting file to the input device 22, and then presses the save button 71 thereby inputting the instruction to save the exceptional setting file to the input device 22, while the window 70 is displayed, the controller 211 stores the exceptional setting file, created at the time that the instruction has been inputted, in the storage device 24, with the designated file name assigned.

Here, when storing the general setting file and the exceptional setting file, the controller 211 convert these files to the data format designated by the instruction inputted to the input device 22, and then store the files in the storage device 24. For example, the controller 211 may convert the general setting file or exceptional setting file of the XJDF data format, to the JDF data format designated by the instruction.

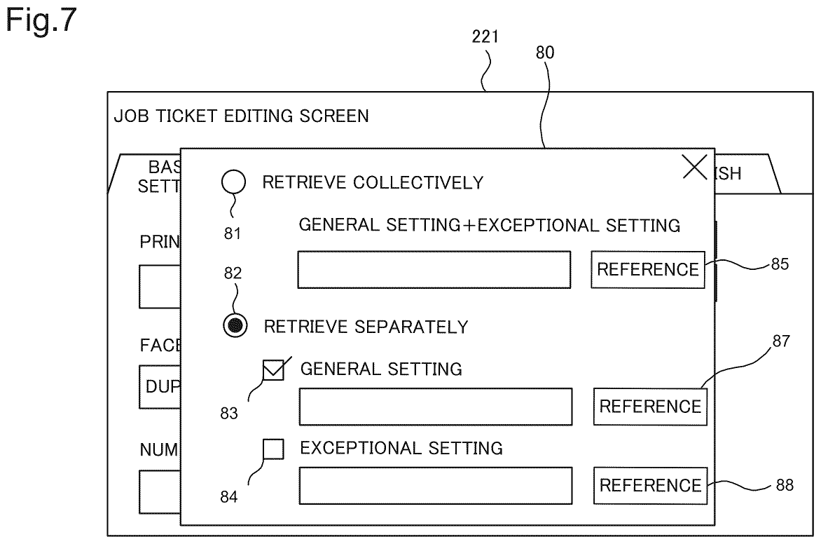

Referring again to FIG. 3, the process of retrieving the general setting file and the exceptional setting file already stored, and generating the job ticket, will be described hereunder. To retrieve the general setting file or exceptional setting file, and generate the job ticket, the user presses a button 52 in the job ticket editing screen G1. When the button 52 is pressed, the controller 211 receives the instruction to display a window 80 via the input device 22, and causes the display device 221 to display the window 80 as shown in FIG. 7, according to the instruction.

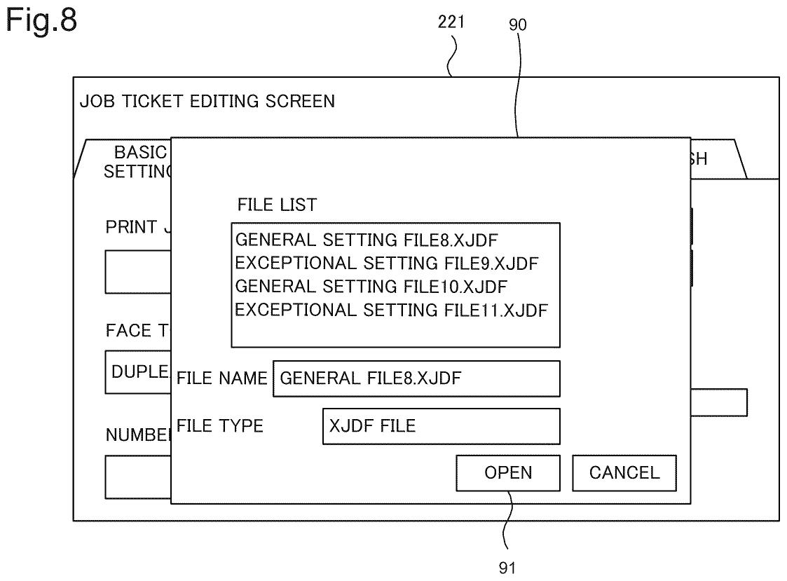

When the user presses a radio button 81 while the window 80 is displayed, the controller 211 receives the instruction to collectively retrieve the general setting file and the exceptional setting file, via the input device 22. When the user presses a reference button 85 at this point, the controller 211 receives the instruction to display a window 90 via the input device 22, and causes the display device 221 to display the window 90 as shown in FIG. 8, according to the instruction.

The window 90 includes a list of files, including the general setting files and the exceptional setting files already stored in the storage device 24 at the time that the window 90 has been displayed. When the user inputs the instruction designating the general setting file and the exceptional setting file to be retrieved, out of the general setting files and the exceptional setting files included in the file list, and then presses an open button 91 thereby inputting the instruction to retrieve the files, associated with the open button 91, to the input device 22, while the window 90 is displayed, the controller 211 retrieves the general setting file and the exceptional setting file that have been designated, from the storage device 24, and generates the job ticket indicating the setting detail specified by the general setting file and the exceptional setting file, in a predetermined data format (in this case, XJDF data format).

The controller 211 transmits the job ticket generated as above to the image forming apparatus 3 via the communication device 23, when the user inputs the print execution instruction (identification of data to be printed inclusive), to the input device 22. Upon receipt of the job ticket via the communication device 35, the controller 311 of the image forming apparatus 3 causes the image forming device 33 to form the image according to the job ticket.

When the user presses a radio button 82 and a checkbox 83 while the window 80 is displayed, the controller 211 receives the instruction to retrieve the general setting file, via the input device 22. At this point, when the user presses a reference button 87, the controller 211 receives the instruction to display the window 90 via the input device 22, and causes the display device 221 to display the window 90, according to the instruction.

The window 90 includes a list of files including the general setting files, out of the general setting files and the exceptional setting files already stored in the storage device 24 at the time that the window 90 has been displayed. When the user inputs the instruction designating the general setting file to be retrieved, out of the general setting files included in the file list, and then presses the open button 91 thereby inputting the instruction to retrieve the file, associated with the open button 91, to the input device 22, the controller 211 retrieves the general setting file that has been designated, from the storage device 24, and generates the job ticket indicating the setting detail specified by the general setting file, in a predetermined data format (in this case, XJDF data format).

According to this embodiment, the job ticket can also be generated, by adding the exceptional setting file retrieved from the storage device 24, to the general setting file retrieved as above.

In this case, upon retrieving the general setting file as above, the user inputs the instruction to retrieve the exceptional setting file to the input device 22, before inputting the print execution instruction thereto. When the instruction to retrieve the exceptional setting file is inputted to the input device 22, the controller 211 causes the display device 221 to display the window 80.

When the user presses the radio button 82 and a checkbox 84 while the window 80 is displayed, the controller 211 receives the instruction to retrieve the exceptional setting file, via the input device 22. At this point, when the user presses a reference button 88, the controller 211 receives the instruction to display the window 90 via the input device 22, and causes the display device 221 to display the window 90, according to the instruction.

The window 90 includes a list of files including the exceptional setting files, out of the general setting files and the exceptional setting files already stored in the storage device 24 at the time that the window 90 has been displayed. When the user inputs the instruction designating the exceptional setting file to be retrieved, out of the exceptional setting files included in the file list, and then presses the open button 91 thereby inputting the instruction to retrieve the file, associated with the open button 91, to the input device 22, the controller 211 retrieves the exceptional setting file that has been designated, from the storage device 24, and generates the job ticket indicating the setting detail specified by the exceptional setting file, and by the general setting file already retrieved, in a predetermined data format (in this case, XJDF data format).

As described thus far, according to the foregoing embodiment, the general setting file and the exceptional setting file, to be used to generate the job ticket, are separately stored. Accordingly, the job ticket can be generated using a general setting file or an exceptional setting file subsequently stored, which leads to improved work efficiency. In addition, separately saving or retrieving the general setting file and the exceptional setting file contributes to reducing the data amount, compared with the case where the general setting and the exceptional setting are collectively stored in a single file, thereby saving the storage region and reducing the data communication amount.

With the arrangement according to the foregoing embodiment, therefore, the setting detail indicated by the job ticket can be easily changed, using the general setting file and the exceptional setting file separately created.

The disclosure may be modified in various manners, without limitation to the configuration according to the foregoing embodiments. Further, the configurations and processings described in the embodiments with reference to FIG. 1 to FIG. 8 are merely exemplary, and in no way intended to limit the disclosure to those configurations and processings.

While the present disclosure has been described in detail with reference to the embodiments thereof, it would be apparent to those skilled in the art that various changes and modifications may be made therein within the scope defined by the appended claims.

What is claimed is:

1. An image forming system comprising:
an image forming device that forms an image on a recording sheet;
a controller including a processor, and configured to cause the image forming device to form the image according to a job ticket, when the processor executes a control program;
a storage device containing a general setting file specifying print setting for all pages, and an exceptional setting file specifying print setting for a predetermined page range, independently from each other; and
an input device to which an instruction of a user is inputted,
wherein the controller retrieves the general setting file or exceptional setting file designated by the instruction inputted to the input device, from the storage device, and generates the job ticket indicating a setting detail specified by the general setting file or exceptional setting file retrieved.

2. The image forming system according to claim 1,
wherein an instruction for designating the exceptional setting file is inputted to the input device, and
the controller generates the job ticket indicating the setting detail specified by the general setting file, created in advance as the general setting file for generating the job ticket, and the setting detail specified by the exceptional setting file designated by the instruction.

3. The image forming system according to claim 1,
wherein an instruction for designating the general setting file is inputted to the input device, and
the controller generates the job ticket indicating the setting detail specified by the exceptional setting file, created in advance as the exceptional setting file for generating the job ticket, and the setting detail specified by the general setting file designated by the instruction.

4. The image forming system according to claim 1,
wherein the storage device includes a network storage located on a network.

5. The image forming system according to claim 1,
wherein, when an instruction for designating the general setting file and the exceptional setting file is inputted to the input device, the controller generates the job ticket indicating the setting detail specified by each of the general setting file and the exceptional setting file, by combining the general setting file and the exceptional setting file designated by the instruction inputted.

6. An electronic terminal comprising:
a controller including a processor, and configured to cause an image forming apparatus to form an image according to a job ticket, when the processor executes a control program;
a storage device containing a general setting file specifying print setting for all pages, and an exceptional setting file specifying print setting for a predetermined page range, separately from each other;
an input device to which an instruction of a user is inputted,
wherein the controller retrieves the general setting file or exceptional setting file designated by the instruction inputted to the input device, from the storage device, and generates the job ticket indicating a setting detail specified by the general setting file or exceptional setting file retrieved.

7. A print control method comprising:
a storage process including separately creating a general setting file specifying print setting for all pages, and an exceptional setting file specifying print setting for a predetermined page range, and storing the general setting file and the exceptional setting file in a storage device;
a job ticket generation process including retrieving the general setting file or exceptional setting file from the storage device, according to an instruction of a user, and generating a job ticket indicating a setting detail specified by the general setting file or exceptional setting file retrieved; and
an image forming process including causing an image forming device to form an image according to the job ticket.
